(19) United States
(12) Patent Application Publication
(10) Pub. No.: US 2004/0259996 A1
(43) Pub. Date: Dec. 23, 2004

(54) High-viscous moulding materials with nano-scale fillers

(76) Inventors: Georg Stoppelmann, Bonaduz (CH); Ralph Kettl, Bonaduz (CH)

Correspondence Address: Bell, Boyd & Lloyd LLC, P.O. Box 1135, Chicago, IL, 60690-1135, US

(21) Appl. No.: 10/646,952

(22) Filed: Aug. 22, 2003

(30) Foreign Application Priority Data
Aug. 27, 2002 (DE) 102 39 326.5

(51) Int. Cl. C08K 3/18; C08K 3/34; C08K 3/40

(52) U.S. Cl. 524/430; 524/492; 524/445; 524/494

(57) ABSTRACT

The present invention relates to high-viscous moulding materials on basis of thermoplastic polymers from the group consisting of polyamides, polyesters, polyether esters, polyester amides or mixtures thereof and nano-scale fillers, i. e. fillers having a medium particle size in the range of smaller than 1 μm. The moulding materials according to the present invention have an increased melt strength as well as an advantageous balanced mechanical property profile even at elevated temperature and are used for the production of moulded articles, hollow bodies, semi-finished products, plates and pipes.

The present invention relates to high-viscous moulding materials which are extremely suitable for the extrusion blow moulding process and based on thermoplastic polymers from the group consisting of polyamides, polyesters, polyether esters, polyester amides or mixtures thereof and nano-scale fillers, i. e. fillers having a medium particle size in the range of smaller than 1 μm. The moulding materials according to the invention have an increased melt strength as well as an advantageous balanced mechanical property profile even at increased temperature and are used for the production of moulded articles, hollow bodies, semi-finished products, plates and pipes.

Hollow bodies made of thermoplastics, and thus also polyamide hollow bodies, can be produced principally according to the extrusion blow moulding method or special methods to be assigned to this method. Thereby, the range of produced products comprises besides the current hollow bodies in the field of packaging—bottles, cans, barrels etc.—a multitude of technical moulded parts, e. g. hollow bodies with applications in the field of the automobile industry such as fuel tanks, spoilers, air conducting channels, suction pipes or suction pipe parts or suction module parts, containers for liquids and sheatings. To an increased extent any imaginable form of pipes and hoses for pressurized and depressurized media can be produced by the recent 3D methods (3D hose manipulations, 3D vacuum blow method). Diverse sheatings and housings for the domestic industry fall in the field of technical parts as well as toy and hollow bodies for the medical technique.

Numerous applications have developed for the polyamide from the group of the technical thermoplastics due to its good barrier properties, its high heat dimensional stability and its high gloss.

The extrusion blow moulding principle is that an extruded melt hose is received by a mostly two-part cooled hollow mould—the negative part of the blow moulded part to be produced—and blown up the finished hollow body by means of compressed air. In most cases the hose produced into the annular die gap of a cross head emerges vertically downwards. As soon as this parison has reached the required length the mould moieties are closed. The cutting edges of the moulds take the hose, bond it and squeeze at the same time the residues projecting upwardly and downwardly. From the process-technical point of view the following requirements result for a raw material in blow moulding:

High melt tenacity or strength (high viscosity), respectively: This requirement results from the necessary hose stability named in the following also melt strength. Even for use of melt storing and low processing temperatures, longer parisons can be produced production-safe and reproducable only from products having correspondingly high hose stability. But, there is the problem that the parison extends under the own weight of the extruded hose. Thereby, apart from the production of very small blow moulded bodies, polyamides having medium and normal melt viscosity, i. e. products having a rel. viscosity ηᵣₑₗ<3,5 (as measured on a 1 wt.-% solution of polyamide 6 in H₂SO₄ at 25° C.) are ruled out for the extrusion blow moulding method. When blowing hollow bodies having a volume exceeding about 0.5 L, one must use extraordinarily high-viscous adjustments (ηᵣₑₗ>4.0; as measured on a 1 wt.-% solution of polyamide 6 in H₂SO4 at 25° C.). Therefore, only the high-molecular, the branched or cross-linked polyamides are suitable as raw materials for the blow method.

High thermal stability: Reasons therefore are the quite long retention time of the material at high temperatures in the parison head as well as the fact that the parison surface is exposed to the oxidative attack of air oxygen during the extrusion and blow-up operation. Good melt extensibility: Substantially, it determines the obtainable blow-up ratio and the wall thickness distribution.

Mixtures of polyamide, a 2. polymeric component and mineral fillers used for extrusion blow moulding are described by CA 130 6562, EP-A-747 439, EP-A-597 648 and WO 95/20011. However, in these cases a second polymer component is always necessary.

Documents DE-A 36 32 865, DE-A 38 08 623, EP-A 0 787 765 and DE-A 196 21 309 describe mixtures of polyamides with silicates, which distinguish by an improved mechanical strength and tenacity. DE-A 196 21 309 uses a fluorine mica polyamide mixture and mentions also the blow moulding as possible application.

Polyamide, i. e. polyamide 6 (without reinforcing agents) having a medium viscosity of ηᵣₑₗ<3,5 (as measured on a 1 wt.-% solution of polyamide 6 in H₂SO₄ at 25° C.) can not be processed by blow moulding, since the polyamide melt does not have a sufficient melt stability.

Composite materials made of organic polymers such as polyamides with platelet-like nano-scale fillers, especially layered silicates (phyllosilicates) are known, as mentioned above. These materials distinguish by a high stiffness. However, besides an improvement of the stiffness, the tenacity decreases by the addition of the phyllosilicates.

A problem in the production of composite materials made of organic polymers and platelet-like nano-scale fillers, especially layered silicates, is the intimate permanent mixture of the inorganic and organic materials.

Therefore, different methods achieving a permanent mixture of the inorganic material with the organic material are described in prior art, wherein on the one side one starts from nano-scale fillers which are not surface-treated.

U.S. Pat. No. 4,789,403 (Toyota) describes the production of compositions made from organic material such as polyamides and layered silicates. Firstly, the layered silicates are intimately mixed with monomers, comonomers or prepolymers in a mill for an improved miscibility with the organic material in untreated form. Then, this powder is polymerized at increased temperature in N₂ atmosphere to the desired composite material. Thereby, all possible layered silicates such as halloysite, illite, kaolinite, montmorillonite or polygorskite can be used as layered silicates.

In a common way a permanent mixture of the organic material with the inorganic material is achieved by modifying the inorganic material in a preceding step.

WO 99/29767 (DSM) describes the production of a polyamide nanocomposite composition by mixing untreated layered silicates and polyamides. This mixture is extruded and then water in amounts of up to 30 wt.-% is injected. This water is then later emerged from the devolatilizing opening. The polyamide nanocomposite composition is extruded as strand and cooled in water.

Then, this strand can be further processed to pellets.

WO 93/0411 (Allied Signal) describes composite materials which have a polymer matrix and platelet-like particles dispersed therein uniformly, especially phyllosilicates. The platelet-like particles are linked with onium compounds according to the general formulas described in the WO 93/04117, i.e. hydrophobized. The hydrophobizing is performed in a step preceding the mixing with the polymers.

Further, a linkage of the organic and inorganic materials can be achieved by a coupling of both components with organosilanes. However, the modification is awkward and expensive.

Further, a permanent mixture of organic material with the inorganic material can be achieved by a surface treatment of the layered silicate (hydrophobizing, cf. WO 93/0411). Such layered silicates comprise intercalated cations in its negatively charged lattice whereby the layer separation between the silicate layers is expanded (delaminated layered silicates) and the layered silicates disintegrate in a subsequent polymerization of the organic monomer in the presence of the layered silicates into individual layers. But, some of the so-treated layered silicates do not delaminate completely. Especially, when the nanocomposites are not produced “in situ” by a direct polymerization of the organic monomers in the presence of the layered silicates, but by a technically substantially more simple mixture of all starting materials, the delamination of the layered silicates is often incomplete. Thereby, the uniform distribution of the individual layers of the layered silicates in the plastic (organic material), especially in a production of the nanocomposites by mixing, is not optimal. This leads to materials which do not have advantageous properties with regard to materials mixed with minerals which are not delaminated.

But, in prior art, there were also made attempts to modify the layered silicates without using a onium ion or a silane adhesion promoter. EP 0 747 323 B1 (AMCOL) describes an intercalate which can be exfoliated by producing it by extruding a mixture of a smectite, an intercalation polymer and a liquid carrier through a die opening.

WO 99/07790 (TNO) describes the modification of smectite clay with a block copolymer made of a polyethylene oxide block and a polystyrene block as polymer matrix. First, the clay is reacted with the polyethylene oxide and then mixed with the polymer matrix and then a copolymer is produced.

In one of the main applications of polymer systems and especially of polyamide systems comprising nano-scale fillers result the effects that the thermal expansion factor is significantly reduced especially in processing direction in comparison to unfilled matrix polymers, wherein the finely distributed particles reduce significantly the permeation of gases and liquids without reducing the tenacity such as in classically filled systems. Therefore, the production of drink bottles can be seen as a main application of thermoplastic nanocomposites, wherein multi-layer systems having a layer made of a moulding material of so-called nanocomposite materials which should reduce the permeation of gases are employed frequently. WO 99/44825 and WO 01/87596 (both Eastman) describe transparent thermoplastic nanocomposite materials which are used in multi-layer systems and have good barrier properties.

Therefore, the main requirements to the materials, as described above, are a high barrier to the permeation of gases such as oxygen or carbon dioxide as well as good transparency. To maintain the transparency of the base polymer, an as complete as possible dispersing of the frequently used layered silicates, for example, montmorillonite, is necessary. To achieve this as complete as possible distribution of the layered silicates, several methods are described (see above). Therefore, to increase the compatibility between polymer and silicate, reduce the interfacial surface tension and facilitate the dispersion of the layers, the sodium ions in the montmorillonite intermediate layers are replaced by onium ions (see above). Examples for this are sulfonium, phosphonium or ammonium compounds. The WO 01/04197 mentions alkoxylated ammonium ions. Also, the reduction of the sodium amount in montmorillonites should facilitate its distribution in a polyamide matrix (EP 0 940 430 B1; Toyota).

Further, the combination of both two silicates (WO 00/34375) and two organic cations are known for modification (WO 00/341809).

Besides layered silicates from natural origin, also synthetic minerals such as fluorine mica which are available by the treatment of talc with alkali silicone fluorides are described (U.S. Pat. No. 5,414,042). The distribution of the silicate layers can be improved in a process by creating firstly a silicate polymer concentrate which is diluted then later to the desired concentration. This can be performed in one process step or in two separated (WO 00/34393). Thereby, this concentrate can be produced also on an oligomer basis (WO 00/34377).

Due to the preferred production method for drink bottles, namely the injection stretch moulding (WO 99/32547) a reduced crystallizability is frequently required. For this, amorphous polymers or oligomers are added to a semi-crystalline polymer. WO 01/40369 (Eastman) mentions a MXD6/MXDI as amorphous polyamide (PA). A high crystallization velocity can result in that a joint line developing in the injection mould process on that location, on which the two melting fronts meet, possesses a significantly lower mechanical strength as the polymer itself. EP 0 885 920 A proposes to combine a polyamide 6 homopolymer or copolymer reinforced with silicate with a unreinforced polyamide to increase the joint line strength.

Commonly, polyester such as polyethylene terephthalate (PET) is used as polymeric material which is commonly employed in the packaging industry for producing bottles, containers etc. Although, e. g., PET possesses a very good oxygen barrier, it is however still insufficient for drinks such as beer etc. having a high CO₂ amount. Therefore, there have been already made attempts to improve the barrier properties of polyesters. WO 93/04118 describes a composite material made of a melt-processable polymer and up to 60 wt.-% of dispersed platelet-like particles. Also, polyester is mentioned according to WO 93/04118 among a plurality of thermoplastic polymers.

To achieve the viscosity required for the production of bottles, polyester moulding materials comprising platelet-like fillers can be post-condensed in the solid phase at temperatures above the glass transition temperature and below the melting point passing a nitrogen stream (WO 98/29499).

Also, methods for producing high-viscous polyamide moulding materials are known: Either a molecular weight increase by solid phase post-condensation is performed or by addition of reactive compounds. The moulding materials prepared by post-condensation can have in spite of the high molar weight at longer moulding times of the polyamide melt the disadvantage that especially at to high water amount the required melt stabilities for the extrusion blow moulding process are not achieved.

On the other side, reactive additives such as carbodiimides, multiple functional isocyanates can lead to uncontrolled cross-linkages, which is expressed at longer residence times by occurence of gel particles. Furthermore, such reactive additives are expensive and limited in their storing stability.

For extrusion blow mouldability, as mentioned above, a as high as possible viscosity is required at low shear rate. Such high viscosities can be achieved for glass fiber reinforced PA66 e. g. by solid phase post-condensation of linear PA66 compounds, i. e., a PA66 of medium viscosity is compounded with, e. g., 25% of glass fiber on a double screw extruder, and then the obtained pellets are subjected to an post-condensation in the solid phase. This can be performed, e. g., in a vacuum tumbling drier or in a continuous inert-gas drier under conditions being well known to those skilled in the art. Normally, the use of high-viscous non-reinforced PA66 as base resin in the compounding does not lead to the desired high-viscous materials, because the high shearing forces and temperatures in the extruder lead to polymer degradation and thus to viscosity reduction.

A further possibility to achieve high-viscous PA66 is the incorporation of long-chain branchings by reactive extrusion, such it has been described, e. g., for glass fiber reinforced PA6, by EP-A 685 528. The application of this branching method by means of bisphenol A diglycidyl ether or with similar branching agents to glass fiber reinforced PA66 leads also to high-viscous extrudable PA66, but the surface quality and compression weld strength of hollow bodies extrusion blow moulded from such compounds are however not sufficient for the most technically relevant applications.

DE 100 22 144 A1 (Bayer) describes moulding materials which comprise 60-90 wt.-% parts of polyamide, 10-40 wt.-% parts of reinforcing materials and 0.5-6 wt.-% parts of nano-scale layered silicates and can be used for producing moulded articles, especially line systems or conduits, respectively, and/or storage systems. The moulding materials according to DE 100 22 144 A1 have only a normal melt strength and are less suitable for the extrusion blow moulding process.

The post-published DE 101 25 560 A1 (BASF) describes the production of moulded parts in an injection mould method, which are made of polyamide nanocomposites comprising 60-99.9 wt.-% of at least a polyamide (A) and 0.1-40 wt.-% of a delaminated layered silicate (B) by introducing a melt comprising (A) and (B) over a sprue in an injection moulding. The polyamide nanocomposites can comprise further common additives in amounts of 0-70 wt.-% as optional component. The moulded parts having improved tenacity according to DE 101 25 560 A1 are produced by injection moulding methods, if special injection moulding conditions are adjusted.

Therefore, it is an object of the present invention to provide high-viscous moulding materials on basis of thermoplastic polymers which can be easily produced and which are suitable for the extrusion blow moulding process and additionally possess a sufficient strength at temperatures of from 150 to 200° C.

These object is achieved according to the invention by high-viscous moulding materials on basis of thermoplastic polymers from the group consisting of polyamides, polyesters, polyether esters, polyester amides or mixtures thereof, which have increased melt strength, which comprise (a) nano-scale fillers in an amount of from 0.5-15 wt.-%, especially in an amount of 2-10 wt.-%, especially preferred in an amount of 4-6 wt.-% per 100 parts by weight of the polymer matrix as well as (b) further fibrous filling agents in amounts of 5-30 wt.-%, especially in amounts of 5-20 wt.-%, especially preferred in amounts of 5-15 wt.-%, (c) impact modifiers in amounts of 3-12 wt.-% per 100 parts by weight of the polymer matrix, and if required further additives (d). Polyamides or polyesters are especially preferred as thermoplastic polymers, especially preferred are polyethylene terephthalate (PET) or polybutylene terephthalate. The high-viscous moulding materials according to the invention which are extremely suitable for the extrusion blow moulding process have a melt strength being about at least 30% higher than that of similar moulding materials which comprise instead of the nano-scale fillers (a) merely current mineral filler materials such as, e.g., amorphous silicic acid, magnesium carbonate (chalk), kaolin, pulverized quartz, mica, talc and feldspar. The determination of the melt strength is explained below, wherein the melt strength is given in seconds. The measured seconds are the time which is required by the hose portion to extend to one meter under the influence of the gravity. The measured values (in seconds) of the various moulding materials are given in the tables 1 and 2 below.

Dependent claims 2-22 comprise advantageous embodiments of the invention. In claim 23, there is described a method for producing the polyamide moulding materials by subsequent compounding the components (a), (b), (c), and if required (d).

Claims 26 and 27 relate to the use of the polyamide moulding materials for the production of moulded articles, hollow bodies, semi-finished products, plates and pipes.

Claim 28 relates to moulded articles obtainable using the polyamide moulding materials. The moulded articles according to the invention can be produced in one or more steps by coextrusion, extrusions blow moulding, compression moulding or sheating methods (cf. claim 29).

In the polymer systems according to the invention, wherein the filler particles (a) have dimensions in the nanometer range, i. e. with a medium particle size of <1 μm (untreated fillers), the following effects result: The thermal expansion coefficient is significantly reduced in comparison to that of unfilled matrix polymers, especially in processing direction, the finely dispersed nanoparticles lead to a significantly higher melt stability (at least 20% increased) in comparison to unmodified polyamide. Also, by virtue of the molecular reinforcement, mechanical properties are improved even at elevated temperatures.

According to the invention, such polymers from the group consisting of polyamides, polyesters, polyether esters, polyester amides or mixtures thereof are used as thermoplastic polymers. However, polyamides or polyesters such as polyethylene terephthalate or polybutylene terephthalate are preferred.

Advantageously, polymerides made of aliphatic C₆-C₁₂ lactams or ω-amino acids having 4 to 44 carbon atoms, preferably 4 to 18 carbon atoms, or polycondensates obtainable from the polycondensation of at least one diamine from the group of the aliphatic diamines having 4 to 18 C atoms, the cycloaliphatic diamines having 7 to 22 C atoms and the aromatic diamines having 6 to 22 C atoms in combination with at least one dicarboxylic acid from the group of aliphatic dicarboxylic acids having 4 to 12 C atoms, cycloaliphatic dicarboxylic acids having 8 to 24 C atoms and aromatic dicarboxylic acids having 8 to 20 C atoms are used as polyamides (PA) for the moulding materials according to the invention. The ω-amino acids or the lactams are selected from the group of ε-amino acid, 11 -aminoundecanoic acid, 12-aminododecanoic acid, ε-caprolactam, enanthlactam, ω-laurinlactam. Further, it is possible according to the invention to use blends of the afore-mentioned polymerides or polycondensates, respectively. Diamines suitable according to the invention which are combined with a dicarboxylic acid are, for example, 2,2,4- or 2,4,4-trimethylhexamethylenediamin, 1,3- or 1,4-bis(aminomethyl)cyclohexane, bis(p-aminocyclohexyl)methane, m- or p-xylylenediamin, 1,4-diaminobutane, 1,6-diaminohexane, 1,10-diaminodecane, 1,12-diaminedodecane, cyclohexyldimethyleneamine, and the dicarboxylic acids are selected from the group of succinic acid, glutaric acid, adipic acid, suberic acid, pimelic acid, suberic acid, azelaic acid, sebacic acid, dodecanedicarboxylic acid, 1,6-cyclohexanedicarboxylic acid, terephthalic acid, isophthalic acid, naphthalenedicarboxylic acid.

Thus, concrete examples for the (co)polyamide for the moulding material according to the invention are such homopolyamides or copolyamides from the group of PA 6, PA 66, PA 11, PA 46, PA 12, PA 1212, PA 1012, PA 610, PA 612, PA 69, PA 10T, PA 12T, PA 12I, mixtures thereof or copolymers on basis of these polyamides, wherein PA 11, PA 12, PA 1212, PA 10T, PA 12T, PA 12T/12, PA 10T/12, PA 12T/106, PA 10T/106 or mixtures thereof are preferred. Also, copolymers on basis of the afore-mentioned polyamides such as PA 12T/12, PA 10T/12, PA 12T/106 and PA 10T/106 are preferred according to the invention. Further, PA 6/66, PA 6/612, PA 6/66/610, PA 6/66/12, PA 6T/66, PA 6/6T, PA 6/6I, PA 6I/6T or mixtures thereof or mixtures such as PA 12/MACMI, PA 66/6I/6T, MXD 6/6 can be used according to the invention. Mixtures of PA 6 and polyamide 66 are especially preferred.

The polyamides (PA 6, PA 66) for the moulding materials according to the invention have a relative viscosity (as measured on a 1.0 wt.-% solution in sulfuric acid at 25° C.) of from 2.3 to 4.0, especially from 2.7 to 3.4.

Suitable polyesters include at least one dioic acid and at least one glycol. The primary dioic acids are terephthalic acid, isophthalic acid, naphthalenedicarboxylic acid, 1,4-cyclohexanedicarboxylic acid, phenylenedioxodiacetic acid and the like. Also, the various naphthalenedicarboxylic acid isomers or mixtures of isomers thereof can be used, wherein 1,4-, 1,5-, 2,6- and 2,7-isomers are preferred. The 1,4-cyclohexanedicarboxylic acids can be used in the form of cis-, trans-, or cis/trans-mixtures.

The dicarboxylic acid component of the polyester can be modified by up to 95% by other different carboxylic acids, if required.

Typical glycols which can be used as polyester building blocks comprise aliphatic glycols having two to ten carbon atoms and cycloaliphatic glycols having seven to fourteen carbon atoms. Preferred glycols are ethylene glycols, 1,4-butanediol, 1,6-hexanediol, 1,4-cyclohexanedimethanol, diethylene glycol and the like. Also, the glycol component can be modified by up to 50 wt.-% by other or further diols.

The polyesters described above form a component of the present invention and can be produced by means of the current methods known by prior art. But, also still other current polymers such as polyesters, polyolefins, polycarbonates, polyethylene, vinyl alcohols can be added to the (co)polyamides described above or mixtures thereof in amounts up to 10 wt.-% for certain purposes. Further, the used (co)polyamides or the moulding materials, respectively comprise current additives (d) such as UV and heat stabilizers, crystallization accelerators, crystallization retardants, flow assistants, lubricants, release agents, flame retardants, dyes as well as agents which can improve the electrical conductivity.

Impact modifiers (c) in amounts of 3-12 wt.-% per 100 parts by weight of the polymer matrix, are added to the thermoplastic polymers according to the invention, especially the polyamides or polyamide moulding materials, respectively, as further additives. These polymers which can be combined with the polyamides and the nano-scale fillers, especially the nanofillers in the sense according to the invention, are functionalized polymers such as polymers or (co)polymers on polyolefin basis which can be grafted by acrylic acid or maleic anhydride. Especially, impact modifiers such as ethylene-propylene rubbers (EPM) or ethylene-propylene-diene rubbers (EPDM) or acrylate rubbers are mentioned herein.

Such materials which can be added in any desired step of the production and thereby can be finely dispersed in a nanometer range are suitable as nano-scale fillers (a) for producing the nanocomposites according to the invention. The nano-scale fillers (a) according to the invention can be surface-treated. But, untreated fillers (a) or mixtures of untreated and treated fillers (a) can also be used. The fillers (a) being not surface-treated have a size of less than 10 μm, especially a size in the range of from 1-5 μm. Ultrafine fillers have a size of about 500 nm. The fillers (a) are preferably minerals which have already a layered structure such as layered silicates, double hydroxides or also graphite.

The nano-scale fillers (a) used according to the invention are chosen from the group comprising the metal or semi-metal oxides or oxide hydrates. In particular, the nano-scale fillers are chosen from the group comprised of oxides and oxide hydrates of an element chosen from the group comprising boron, aluminum, calcium, gallium, indium, silicon, germanium, tin, titanium, zirconium, zinc, yttrium or iron.

In one particular embodiment of the invention the nano-scale fillers (a) are either silicon dioxide or silicon dioxide hydrates. In one embodiment, the nano-scale fillers are present in the polyamide moulding material as an uniformly dispersed, layered material. Prior to being incorporated into the matrix they have a layer thickness of 0.7 to 1.2 mm and an interlayer separation of the mineral layers of up to 5 nm.

Minerals preferred according to the invention which already have a layered structure are layered silicates, double hydroxides such as hydrotalcite or even graphite. Nano-fillers based on silicones, silica or silsesquioxanes (see illustration) are also suitable according to the invention.

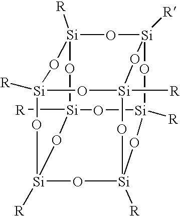

Illustration: Silsesquioxane

In the context of this invention, layered silicates are understood to be 1:1 and 2:1 layered silicates. In these systems, layers of SiO₄ tetrahedrons are regularly linked together with layers comprised of M(O,OH)₆₋ octahedrons. Therein, M represents metal ions like Al, Mg, Fe. In the 1:1 layered silicates one tetrahedron layer is connected with one octahedron layer respectively. Examples of this are kaolin and serpentine minerals.

In the case of the 2:1 layered silicates two tetrahedron layers are combined with one octahedron layer respectively. If all octahedron places are not available with cations of the required charge for compensation of the negative charge of the SiO₄ tetrahedrons and the hydroxide ions, charged layers occur. This negative charge is balanced by the insertion of monovalent cations like potassium, sodium or lithium or divalent cations such as calcium into the space between the layers. Examples of 2:1 layered silicates are talc, mica, vermiculites, illites and smectites, wherein the smectites to which belongs also montmorillonite can be easily swelled with water due to their layer charge. Furthermore, the cations are easily accessible for exchange processes.

The layer thickness of the layered silicates are before the swelling commonly 0.5-2.0 nm, especially preferred 0.8-1.5 nm (distance of the layer upper edge to the following layer upper edge). Herein, it is possible to increase the layer separation further by reacting the layered silicate, for example with polyamide monomers, e. g. at temperatures of 25-300° C., preferably 80-280° C. and in particular 80-160° C. over a retention time of generally 5-120 minutes, preferably 10-60 minutes (swelling). In dependence of the kind of the retention time and the kind of the chosen monomer, the layer separation increases additionally about 1-15 nm, preferably 1-5 nm. Generally, the length of the platelets is up to 800 nm, preferably up to 400 nm. Generally, possibly present or building-up prepolymers contribute also for swelling of the layered silicates.

The swellable layered silicates are characterized by their ion exchange capacity CEC (meq/g) and their layer separation d_{L}. Typical values for CEC are between 0.7 to 0.8 meq/g. The layer separation in a dry, untreated montmorillonite is 1 nm and increases up to 5 nm with swelling with water or coating with organic compounds.

Examples of cations which can be used for exchange reactions are ammonium salts of primary amines having at least 6 carbon atoms such as hexane amine, decane amine, dodecane amine, stearyl amine, hydrated fatty acid amines or even quaternary ammonium compounds such as ammonium salts of α-, ω-amino acids with at least 6 carbon atoms. Other activation reagents containing nitrogen are the triazine-based compounds. Such compounds are described, for example, in EP-A-1 074 581,therefore, particular reference is made to that document.

Chlorides, sulfates or even phosphates are suitable anions. Also, along with the ammonium salts, sulfonium or phosphonium salts such as tetraphenyl or tetrabutyl phosphonium halides, for example, can be used.

Since polymers and minerals commonly have very different surface tensions, also, bonding agents can be used according to the invention in addition for treating the minerals for cation exchange. When this is done, titanates or even silanes such a γ-amino propyl triethoxy silane are appropriate.

Thus, as described above, layered silicates which are modified by onium ions can be used according to the invention. But, there is also the possibility to use phyllosilicates which are not surface-treated and are reacted then according to WO 99/29767(DSM). Then, the polyamide nanocomposite is produced in such a manner that one mixes firstly the polyamide with the untreated clay mineral in a mixer, gives these mixture into the feed zone of an extruder, and injects after production of a melt up to 30 wt.-% of water, lets escape the water by the devolatilizing opening and then let discharge the melt by a nozzle. Then, the obtained strand can be further processed to pellets.

According to the invention, fibrous filling agents in amounts of 5-30 wt.- %, especially in amounts of 5-20 wt.-%, especially preferred in amounts of 5-15 wt.-%, per 100 parts by weight of the polymer matrix are added as further fillers (b). Examples of suitable fibrous fillers are glass fibers, especially E-glass fibers, carbon fibers, potassium titanate whisker, or aramide fibers. In the use of glass fibers, these can be finished with a sizing and an adhesive for a better compatibility with the matrix material. Generally, the carbon fibers and glass fibers used have a diameter in the range of 6-16 μm. The incorporation of the glass fibers can be performed both in form of short glass fibers and in form of continuous strands (rovings).

In addition, the moulding materials according to the invention can comprise further additives (d). For example, process assistants, stabilizers and oxidation retardants, agents against thermal decomposition and decomposition by ultraviolet light, lubricants and release agents, flame retardants, dyes, pigments and softeners are to mention as such additives.

Generally, pigments and dyes are comprised in amounts of 0-4 wt.-%, preferably of 0.5-3.5 wt.-% and especially preferred of 0.5-2 wt.-%, based on the total weight of the composition. The pigments for coloring thermoplastics are generally known, see, e. g., R. Gäichter und H. Müller, Taschenbuch der Kunststoffadditive, Carl Hanser Verlag, 1983, p. 494-510. White pigments such as zinc oxide, zinc sulfide, lead carbonate (2 PbCO₃ Pb(OH)₂), lithopone, antimony white and titanium dioxide are to mention as first preferred group of pigments. Especially, from the two customary crystal modifications (rutile and anatase type) of the titanium dioxide, the rutile form is used for whitening the thermoplastic nanocomposites according to invention.

Black colouring pigments which can be used according to the invention are iron oxide black (Fe₃O₄), spinel black (Cu(Cr,Fe)₂O₄), manganese black (mixture of manganese dioxide, silicon dioxide and iron oxide), cobalt black and antimony black as well as especially preferred carbon black, which is used mostly in the form of fiunace black or gas black (see therefore G. Benzing, Pigmente für Anstrichmittel, Expert-Verlag (1998), p.78 ff.).

Obviously, for adjusting certain tints, inorganic coloured pigments such as chrome oxide green or organic coloured pigments such as azo pigments and phthalocyanines can be used according to the invention. Generally, such pigments are commercially available.

Further, it can be advantageous to use the mentioned pigments or dyes, respectively, in mixtures, e. g. carbon black with copper phthalocyanines, since the colour dispersion in the thermoplastics is generally facilitated. Oxidation retardants and heat stabilizers which can be added to the thermoplastic materials according to the invention are, e. g., halides from metals of the group I of the classification of elements, e. g. sodium, potassium, lithium halides, if required in combination with copper (I) halides, e. g. chlorides, bromides or iodides. Also, the halides, especially of the copper can comprise further electron-rich t-ligands. As example for such copper complexes are mentioned Cu halide complexes with e. g. triphenylphosphine. Further, sterically hindered phenols, if required in combination with phosphoric acids or salts thereof, respectively, and mixtures of these compounds, generally in concentrations of up to 1 wt.-%, based on the weight of the mixture can be used.

Examples for UV stabilizers are various substituted benzotriazoles and benzophenones which are used generally in amounts of up to 2 wt.-%.

Lubricants and release agents which are added generally in amounts of up to 1 wt.-% to the thermoplastic material are stearic acid, stearyl alcohol, stearic acid alkylester and stearic acid amides as well as esters of the pentaerythrite with long-chain fatty acids. Also, calcium, zinc or aluminium salts of the stearic acid can be used.

The production of the high-viscous moulding materials according to the invention can be performed in various ways. Diverse method operations can be used for the production of the moulding materials according to the invention. E. g., the production can be performed by a method operated continuously or discontinuously. Theoretically, the production of the moulding materials according to the invention can be performed by incorporating the layered silicates, the fibrous filling agents and the impacts modifiers during the polymerization or by subsequent compounding by an extrusion method. E. g., such production instructions can be taken from the DE-A-199 48 850.

But, it was found according to the invention that if one produces the layered silicates, the fibrous filling agents and the impact modifiers by subsequent compounding by an extrusion method, one can produce specially high-viscous moulding materials extremely suitable for the extrusion blow moulding process.

Therefore, the nanocomposite moulding materials are produced in a special embodiment by means of extrusion method, i.e. on an extruder, especially a 30 mm double screw extruder ZSK 25 of the company Werner & Pfleiderer at temperatures between 240° C. and 350° C. Thereby, the polymers are firstly molten and the silicate mineral is fed in the feed zone of the extruder, and if required the glass fibers, are fed into the melt and the obtained nanocomposites are formulated.

But, as an alternative, it is also possible that the layered silicate is mixed with the polymerizable monomers in suspension, or as solid. Thereby, the polymers and the silicate mineral are put in the feed zone of an extruder, and if required glass fibers, are metered into the melt. If required, these obtained nanocomposites are then formulated with the further components such as the mineral fillers and the impact modifiers, and if required further additive.

In the alternative method, as described above, the nano-scale fillers are mixed in suspension or as solid with the monomer polymerizable to the thermoplastic. Then a swelling of the layered silicates with the monomers occurs. The subsequent polymerization of the monomers can be performed in a common way. Then, the obtained nanocomposites are formulated, if required, with further components such as filling agents, impact modifiers and the further additives.

In the sense of the present invention the mixture of the components, from which the nanocomposites are constituted, e. g. the extruder, to the finished nanocomposite is to be understood by formulation.

In a further preferred embodiment the thermoplastic nanocomposites according to the invention can be obtained by mixing the polyamide and the layered silicate, and if required, the further mineral filling agents, and if required the impact modifier and the other additives according to methods generally known, e. g. by means of extrusion at temperatures in the range of 160-350° C., especially preferred at 240-300° C. Especially, a double screw extruder having high shearing is suitable, wherein preferably shear stresses according DIN 11443 of from 10 to 105 Pa, especially of 10² to 10⁴ Pa are present.

The obtained thermoplastic nanocomposites according to the invention distinguish especially by an increased melt strength. They can be used for producing moulded articles.

Further, subject matter of the application is the use of the moulding materials according to the invention for producing moulded articles, hollow bodies, semi-finished products, plates, pipes etc. Preferred processing methods are the profile extrusion method, the blow moulding, wherein by blow moulding is to be understood preferably standard extrusion blow moulding, 3D-extrusion blow moulding methods and the vacuum blow moulding methods. Further, subject matter of the application is a moulded article produced from the moulding materials according to the invention. Moulded articles according to the invention are for example:

Radiator pipes, radiator tanks, compensator reservoir and other media conducting pipes and containers, air conduction parts which can be used especially for higher temperature such as pipes in turbo-supercharger.

The following examples explain the invention additionally without limiting it.

### EXAMPLES

### Used Materials

Polyamides

| | | | Volume flow |
|---|---|---|---|
| | Relative viscosity | Relative viscosity | index (MVR) at |
| Polyamide | 1% in sulfuric acid | 0.5% in m-cresol | 275° C./5 kg |
| type | 25 C. ° | 25 C. ° | (cm³/10 min) |
| PA6 | 3.4 | | 30 |
| PA66 | 2.7 | | 60 |
| PA12 | | 2.25 | 25 |

Layered Silicate

Na-montmorillonite treated by 30 meq/100 g mineral methyl, stearyl, bis-2-hydroxyethyl ammonium chloride.

d_{L}: 1.85 nm

Impact Modifier

Ethylene propylene copolymer grafted with maleic anhydride

MVR 275° C./5 kg: 13 cm³/10 min

Melting point DSC: 55° C.

Glass Fiber

E-glass, polyamide type, diameter 10 μm, length 4.5 mm

The nanocomposite moulding materials according to the invention were produced on a 30 mm double screw extruder ZSK 25 of the company Wemer&Pfleiderer at temperatures between 240 and 300° C. Thereby, the polymers and the silicate mineral were metered into the feed zone of the extruder, and if required glass fibers, were metered into the melt.

The test of the inventive and non-inventive moulding materials were performed according to the following regulations:

MVI: (melt volume index) at 275° C./21.6 kg according to ISO 1133

SZ: impact resistance according to ISO 179/1eU

MVR: Volume flow index at 275° C./5 kg (cm³/10 min)

Yield stress, elongation at tear and modulus of elasticity were determined according to ISO527. The determination of the melt strength was performed according to the following method:

The moulding material is molten in a single screw extruder and a hose is extruded from a vertical nozzle at constant throughput. Thereby, the melt strength in seconds is the time which is required by the hose portion to extend to 1 m under the influence of the gravity.

As it is shown in the tables below, the polyamide moulding materials according to the invention have an increased melt strength. For polyamides 6 and 66 or mixtures of polyamides 66 and 6, respectively, increased melt strengths are measured at 275° C. and, namely of at least 15 seconds. For polyamide 12, increased melt strengths of at least 25 seconds are measured at 275° C., each in comparison with common polyamide moulding materials which are not modified by nano-scale fillers and contain merely mineral filler materials.

In the tables below, there are shown the advantages of the moulding materials according to the invention, wherein the experiments starting with C are the non-inventive comparison examples.

TABLE 1
Non-reinforced polyamides

| | | 1 | C1 | 2 | C2 | 3 | C3 |
|---|---|---|---|---|---|---|---|
| PA6 | | 94 | 100 | 47 | 50 | — | — |
| PA66 | | — | — | 47 | 50 | — | — |
| PA12 | | — | — | — | — | 94 | 100 |
| Layered silicate | | 6 | — | 6 | — | 6 | |
| | | — | — | — | — | — | — |
| Melt strength 240° C. | s* | — | — | — | — | 27 | 21 |
| Melt strength 260° C. | s* | 20 | 6 | — | — | — | — |
| Melt strength 280° C. | s* | — | — | 15 | 7 | — | — |

*s = seconds

TABLE 2
Reinforced polyamides

| | | 4 | 5 | C4 |
|---|---|---|---|---|
| PA6 | | 40 | 39 | 42 |
| PA66 | | 40 | 39 | 42 |
| Impact modifier | | 4 | 6 | 6 |
| Layered silicate | | 6 | 6 | — |
| Glass fiber | | 10 | 10 | 10 |
| Melt strength 280° C. | S | 42 | 50 | 15 |
| MVI 275° C./21, 6 kg | cm³/10 min | 94 | 50 | 170 |
| Modulus of elasticity 23° C. | MPa | 5750 | 5600 | 4900 |
| Modulus of elasticity 100° C. | MPa | 1900 | 1800 | 1200 |
| Modulus of elasticity 150° C. | MPa | 1450 | 1330 | 1150 |

1: A high viscous moulding material suitable for an extrusion blow moulding process and based on at least one thermoplastic polymer selected from the group consisting of polyamides, polyesters, polyether esters, polyester amides and mixtures thereof comprising:
(a) nano-scale fillers in an amount of from 0.5 to 15 wt.-% per 100 parts by weight of the polymer matrix
(b) fibrous filling agents in amounts of from 5 to -30 wt.-% per 100 parts by weight of the polymer matrix and
(c) impact modifiers in amounts of from 3 to -12 wt.-% per 100 parts by weight of the polymer matrix, wherein the moulding material has a melt strength of about at least 30% higher than that of a similar moulding material comprising instead of the nano-scale fillers (a) typical mineral filler materials.

2: The moulding material according to claim 1, wherein the nano-scale fillers comprise from 2 to-10 wt.-% per 100 parts by weight of the polymer matrix in the moulding material.

3: The moulding material according to claim 1, wherein the nano-scale fillers comprise from 4 to-6 wt.-% per 100 parts by weight of the polymer matrix in the moulding material.

4: The moulding material according to claim 1, wherein the fibrous filling agents comprise from 5 to about-20 wt.-% per 100 parts by weight of the polymer matrix in the moulding material.

5: The moulding, material according to claim 1, wherein the fibrous filling agents comprise from 5 to about-15 wt.-% per 100 parts by weight in the moulding material.

6: The moulding material according to claim 1, wherein the thermoplastic polymer is chosen from the group consisting of polyamides and polyesters.

7: The moulding material according to claim 1, wherein the nano-scale fillers are selected from the group consisting of oxides, semi-metal oxides, and oxide hydrates.

8: The moulding material according to claim 7, wherein the nano-scale fillers are selected from the group consisting of the oxides and oxide hydrates of an element selected from the group consisting of boron, aluminium, magnesium, calcium, gallium, indium, silicon, germanium, tin, titanium, zirconium, zinc, yttrium, iron and talc.

9: The moulding material according to claim 8, wherein the nano-scale fillers are selected from the group consisting of silicon dioxide and silicon dioxide hydrates.

10: The moulding material according to claim 1, wherein the polyamide moulding material in the polyamide matrix comprises a uniformly dispersed, layered mineral as filler having a layer thickness of 0.7 to 1.2 nm and an interlayer separation of the mineral layers of up to 5 nm prior to being incorporated in the polyamide matrix.

11: The moulding material according to claim 1, comprising a mineral uniformly dispersed in the polymer matrix having a cation exchange capacity of from 0.5 to 2 meq/g mineral.

12: The moulding material according to claim 1, comprising a mineral treated by an activating or modifying agent selected from the group consisting of triazines, the ammonium salts of primary amines having at least 6 carbon atoms, quartemary ammonium compounds, ammonium salts of α-, ω-amino acids having at least 6 carbon atoms, sulfonium salts and phosphonium salts.

13: The moulding material according to claim 1, wherein the nano-scale fillers are layered silicates selected from the group consisting of montmorillonite, saponite, beidellite, nontronite, hectorite, stevensite, vermiculite, illite, pyrosite, the group of the kaoline and serpentine minerals, double hydroxides, graphite, and such fillers on basis of silicones, silican and silsesquioxanes.

14: The moulding material according to claim 1, comprising a mineral treated by an adhesion promoter and the adhesion promoter comprses up to 2 wt.-% of the moulding material per 100 parts by weight of the polymer matrix.

15: The moulding material according to claim 1, wherein the (co)polyamides are polymerides selected from the group consisting of aliphatic C₆-C₁₂ lactams and ω-amino acids having 4 to 44 carbon atoms, or copolymers, obtainable from the polycondensation of at least one diamine from the group of the aliphatic diamines having 4 to 12 C atoms, the cycloaliphatic diamines having 7 to 22 C atoms and the aromatic diamines having 6 to 22 C atoms in combination with at least one dicarboxylic acid from the group of aliphatic dicarboxylic acids having 4 to 12 C atoms, cycloaliphatic dicarboxylic acids having 8 to 24 C atoms and aromatic dicarboxylic acids having 8 to 20 C atoms.

16: The moulding material according to claim 15, wherein the ω-amino acids and the lactams are selected from the group consisting of ε-aminocaproic acid, 11-aminoundecanoic acid, 12-aminododecanoic acid, ε-caprolactam, enanthlactam, and ω-laurinlactam.

17: The moulding material according to claim 15, wherein the diamines are selected from the group consisting of 2,2,2-4 or 2,4,4-trimethylhexamethylenediamin, 1,3- or 1,4-bis(aminomethyl)cyclohexane, bis(p-aminocyclohexyl)methane, m- or p-xylylenediamine, 1,4-diaminobutane, 1,6-diaminohexane, 1,10-diaminodecane, 1,12-diaminododecane, and cyclohexyldimethyleneamine, and the dicarboxylic acids are selected from the group consisting of succinic acid, glutaric acid, adipic acid, suberic acid, pimelic acid, suberic acid, azelaic acid, sebacic acid, dodecanedicarboxylic acid, 1,6-cyclo-hexanedicarboxylic acid, terephthalic acid, isophthalic acid, and naphthalenedicarboxylic acid.

18: The moulding material according to claim 1, wherein the polyamides are selected from the group consisting of polyamide 6, polyamide 46, polyamide 6 6, polyamide 11, polyamide 12, polyamide 12 12, polyamide 6 10, polyamide 6 12, polyamide 6 9, polyamide 12 T, polyamide 10 T, polyamide 12 I, polyamide 12 T/12, polyamide 10 T/12, polyamide 12 T/10 6, polyamide 10 T/10 6, polyamide 6/6 6, polyamide 6/6 12, polyamide 6/6 6/6 10, polyamide 6/6 6/12, polyamide 6/6 T, polyamide 6/6 I, polyamide 6T/66, polyamide 12/MACMI, polyamide 66/6I/6T, polyamide MXD6/6 and mixtures, blends or alloys thereof.

19: The moulding material according to claim 1, wherein additional polymers from the group consisting of the polyesters, polyolefins, polycarbonates, and polyethylene vinyl alcohols are added in amounts of up to 30 wt.-% to the moulding materials.

20: The moulding material according to claim 1, comprising additives selected from the group consisting of the UV and heat stabilizers, antioxidant agents, pigments, dyes, nucleation agents, crystallization accelerators, crystallization retardants, flow assistants, lubricants, release agents, flame retardants, and agents improving the electrical conductivity.

21: The moulding material according to claim 1, wherein the fibrous filling agents are glass fibers.

22: The moulding material according to claim 1, wherein the impact modifiers are polyolefins grafted by acrylic acid and maleic anhydride.

23: A method for producing moulding materials comprising the steps of melting polymers selected from the group consisting of polyamides, polyesters, polyether esters, polyester amides and mixtures thereof, and then compounding nano-scale fillers in an amount of from 0.5 to 15 wt.-% per 100 parts by weight of the polymer matrix, fibrous filling agents in amounts of from 5 to 30 wt.-% per 100 parts by weight of the polymer matrix and impact modifiers in amounts of from 3 to 12 wt.-% per 100 parts by weight of the polymer matrix by an extrusion method to produce a high-viscous moulding material having a melt strength of about at least 30% higher than that of a similar moulding material comprising instead of the nano-scale fillers typical mineral filler materials.

24: The method according to claim 23, wherein the moulding materials are produced in a double screw extruder at temperatures of between 240° C. to 350° C.

25: A method for producing moulding materials a high-viscous moulding material suitable for an extrusion blow moulding process and based on at least one thermoplastic polymer selected from the group consisting of polyamides, polyesters, polyether esters, polyester amides and mixtures thereof and including: (a) nano-scale fillers in an amount of from 0.5 to 15 wt.-% per 100 parts by weight of the polymer matrix (b) fibrous filling agents in amounts of from 5 to 30 wt.-% per 100 parts by weight of the polymer matrix and (c) impact modifiers in amounts of from 3 to 12 wt.-% per 100 parts by weight of the polymer matrix, wherein the moulding material has a melt strength of about at least 30% higher than that of a similar moulding material composing instead of the nano-scale fillers (a) typical mineral filtler materials comprising the steps of performing a melt intercalation, wherein the thermoplastic, the nano-scale fillers, the fibrous filling agents (b), the impact modifiers (c), are mixed at temperatures in the range of from 160 to-350° C. and up to 30 wt.-% of a liquid, is injected into the melt.

26: A method for producing a moulded article, hollow body, semi-finished product, plate, or pipe comprising the step of using a high-viscous moulding material suitable for an extrusion blow moulding process and based on at least one thermoplastic polymer selected from the group consisting of polyamides, polyesters, polyether esters, polyester amides and mixtnres thereof:
(a) nano-scale fillers in an amount of from 0.5 to 15 wt.-% per 100 parts by weight of the polymer matrix
(b) fibrous filling agents in amounts of from 5 to 30 wt.-% per 100 parts by weight of the polymer matrix and
(c) impact modifiers in amounts of from 3 to 12 wt.-% per 100 parts by weight of the polymer matrix, wherein the moulding material has a melt strength of about at least 30% higher than that of a similar moulding material comprising instead of the nano-scale fillers (a) typical mineral filler materials.

27: The method according to claim 26, wherein the hollow body is a bottle.

28: A moulded article comprising a high-viscous moulding material suitable for an extrusion blow moulding process and based on at least one thermoplastic polymer selected from the group consisting of polyamides, polyesters, polyether esters, polyester amides and mixtures thereof:
(a) nano-scale fillers in an amount of from 0.5 to 15 wt.-% per 100 parts by weight of the polymer matrix
(b) fibrous filling agents in amounts of from 5 to 30 wt.-% per 100 parts by weight of the polymer matrix and
(c) impact modifiers in amounts of from 3 to 12 wt.-% per 100 parts by weight of the polymer matrix, wherein the moulding material has a melt strength of about at least 30% higher than that of a similar moulding material comprising instead of the nano-scale fillers (a) typical mineral filler materials.

29: The method for producing a moulded article according to claim 27 comprising the use of a step chosen from the group consisting of coextrusion, extrusion blow moulding, compression moulding and sheating methods.

30: The moulding material according to claim 6, wherein the polyester is chosen from the group consisting of polyethylene terephthalate and polybutylene terephthalate.

31: The moulding material according to claim 1, comprising a mineral uniformly dispersed in the polymer matrix having a cation exchange capacity of from 0.7 to 0.8 meq/g mineral.

32: The moulding material according to claim 12, wherein the ammonium salts of primary amines having at least 6 carbon atoms are selected from the group consisting of hexane amine, decane amine, dodecane amine, stearyl amine, and hydrated fatty acid amines.

33: The moulding material according to claim 21, wherein the glass fibers are E glass fibers.

34: The moulding material of claim 22, wherein the polyolefins are grafted by a rubber selected from the group consisting of ethylene-propylene rubbers (EPM), ethylene-propylene-diene rubbers (EPDM) and acrylate rubbers.

35: The method for producing moulding material according to claim 25, wherein the liquid comprises water.
